(19) United States
(12) Patent Application Publication
(10) Pub. No.: US 2020/0147763 A1
(43) Pub. Date: May 14, 2020

(54) Pawl Wrench of Multiple Working Dimensions

(71) Applicant: YE TEN TOOL CO., LTD, Changhua City (TW)

(72) Inventor: Yang-Hua Lee, Changhua City (TW)

(21) Appl. No.: 16/186,597

(22) Filed: Nov. 12, 2018

(51) Int. Cl. B25B 13/28

(52) U.S. Cl. CPC B25B 13/28

(57) ABSTRACT

The present invention is formed by the elements including a pull rod having a header arranged thereon, a driving plate coupled with the header, a plurality of pawls, and an adjustment member coupled with the pull rod. The header has a blind hole and a plurality of first rails arranged on the closed end of the blind hole. The driving plate defines a plurality of bearing portions in the blind hole and has a plurality of external teeth on the periphery thereof. The pawls are surroundingly arranged in the blind hole, crossing adjacent bearing portions and first rails, pivot jointed on the bearing portions with stud shafts, and utilizing second rails thereof to match the first rails, so as to symmetrically define a hexagonal hole. The adjustment member meshes with the external teeth, such that it can drive the driving plate to rotate and control the pawls to swing along predetermined tracks, so as to adjust the bore dimension of the hexagonal hole in a stepless manner, which allows it to be utilized in screwing or unscrewing nuts or screwheads of various sizes and to provide easy and universal utilization.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a wrench, which dimension is stepless adjustable for nuts or screwheads of various sizes, and more particularly, to the technology field regarding pawls that are two-point supported to swing along predetermined tracks.

### Description of Related Arts

According to the conventional technology, such as “Wrench of Steplessly Adjustable Working Dimensions” (unofficial translation), Taiwan Patent No. 098117566 (certificate no. 1353285), illustrated, the main body of the wrench has a hexagon hole penetrated thereon, wherein each side of the hexagon hole has a limb slidably arranged thereon, wherein one of the limb has a driving shaft, so as to utilize the rotation of a worm to drive the driving shaft and, consequently drive the limb of the driving shaft to slip along the hexagon hole, so as to push the rest five limbs in order and to steplessly adjust the working dimensions of the wrench. Unfortunately, this patent only lasts for one year and at least has the following drawbacks.

First, the entire limb set relies only one driving shaft of one of the limb to bear the torque, which is an one-point locating technology disadvantageous in not only concentration of stress, but also difficulty to ensure that the limb set will act according to the designed path when it is driven by the worm.

Second, it has to additionally install a lower fixed plate on the bottom if the hexagon hole and an adjustment base on the top of the hexagon hole, so as to limit the limb set to slip along the hexagon hole rather than coming out therefrom. However, this type of structure will also restrict the limb set from clamping relatively large or small nuts or screwheads. In other words, its overall structure will reduce its universal dimensions and utilization.

Hence, the present inventor, in view of the above drawbacks of the conventional technology, by continuous improvement and constant studying and testing, has invented the present invention that is able to solve the above mentioned issues of the prior art as well as to provide more universal dimensions and utilization.

### SUMMARY OF THE PRESENT INVENTION

The present invention provides a pawl wrench of multiple working dimensions, comprising:

a pull rod, comprising a header arranged thereon, wherein the header has a blind hole arranged thereon, wherein the blind hole has an open end, a closed end, and a plurality of first rails arranged on the closed end in an equiangular manner;

a driving plate, coupled with the header, wherein the driving plate has a plurality of bearing portions defined in the blind hole in an equiangular manner and a plurality of external teeth on the periphery thereof;

a plurality of pawls, surroundingly arranged in the blind hole and crossing adjacent the bearing portions and the first rails, wherein each pawl has a stud shaft and a second rail respectively, wherein the pawls are pivot jointed on the bearing portions through the stud shafts respectively and match the second rails with the first rails, so as to symmetrically define a hexagonal hole with the pawls; and

an adjustment member coupled with the pull rod, adapted for driving the external teeth to rotate the driving plate, so as to control the pawls to swing along predetermined tracks, so as to adjust the bore dimension of the hexagonal hole in a stepless manner, which allows it to be utilized in screwing or unscrewing nuts or screwheads of various sizes.

Therefore, the pawls swing along the stud shafts and swing in predetermined tracks by the passive coordination of the first and second rails. This is a two-point locating technology advantageous in not only dispersive stress, but also guarantee on that the pawls will act according to the designed path, such that the issues of the above conventional technology can be resolved.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is an exploded view of the wrench according to the present invention.

FIG. 2 is a perspective view illustrating a first assembling action according to the present invention.

FIG. 3 is a perspective view illustrating a second assembling action according to the present invention.

FIG. 4 is a perspective view illustrating the assembled wrench according to the present invention.

FIG. 5 is a top view illustrating a hexagonal hole of the wrench in the maximum bore dimension according to the present invention.

FIG. 6 is a sectional view of FIG. 5 along the top surface of a driving plate of the wrench.

FIG. 7 is a top view illustrating a hexagonal hole of the wrench in the minimal bore dimension according to the present invention.

FIG. 8 is a sectional view of FIG. 7 along the top surface of a driving plate of the wrench.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

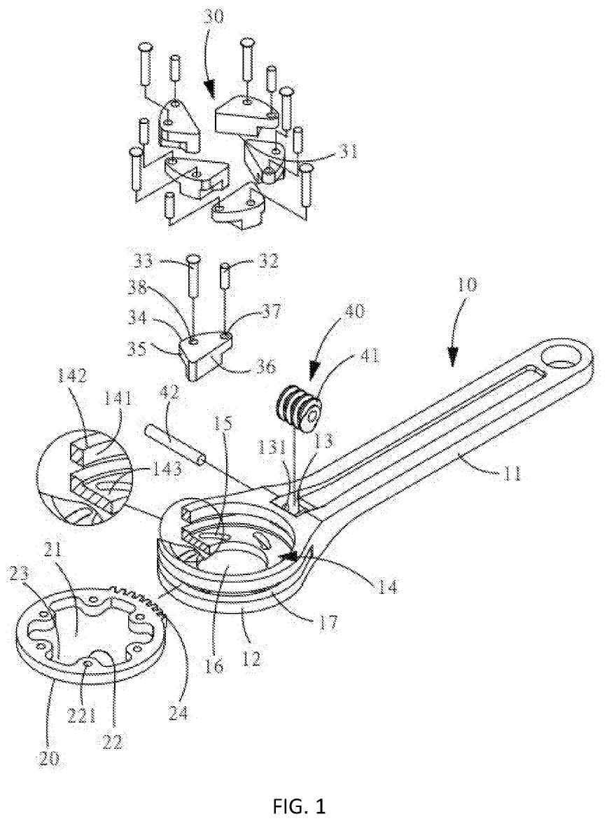

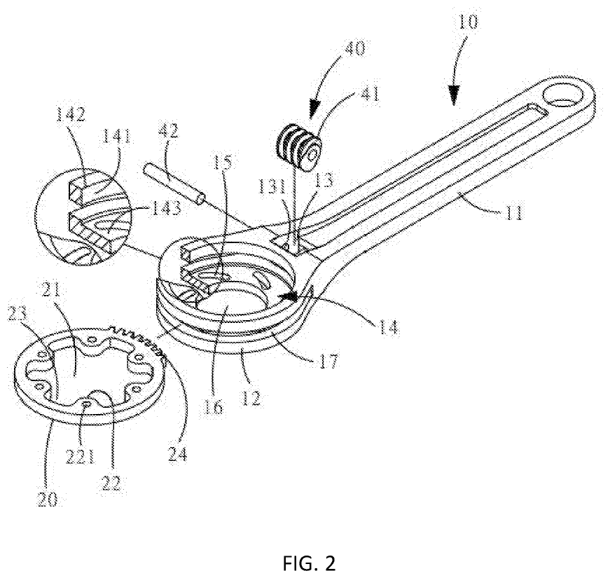

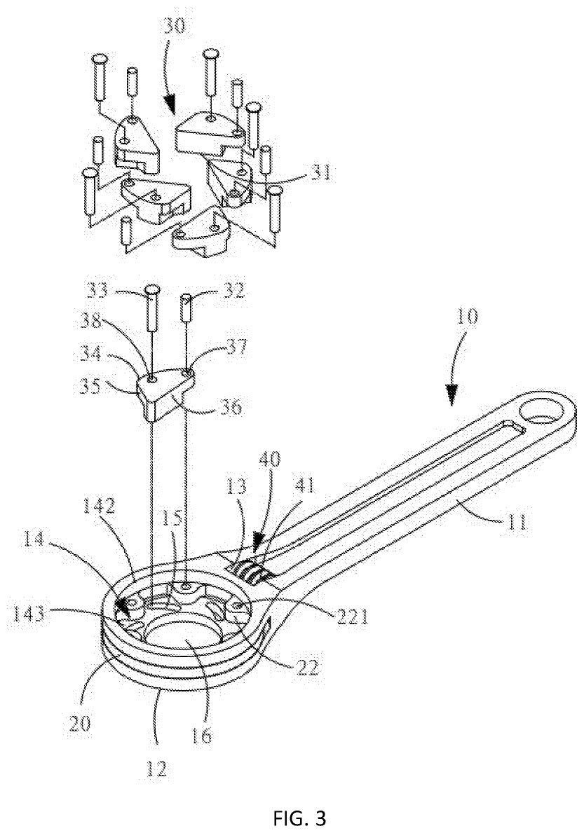

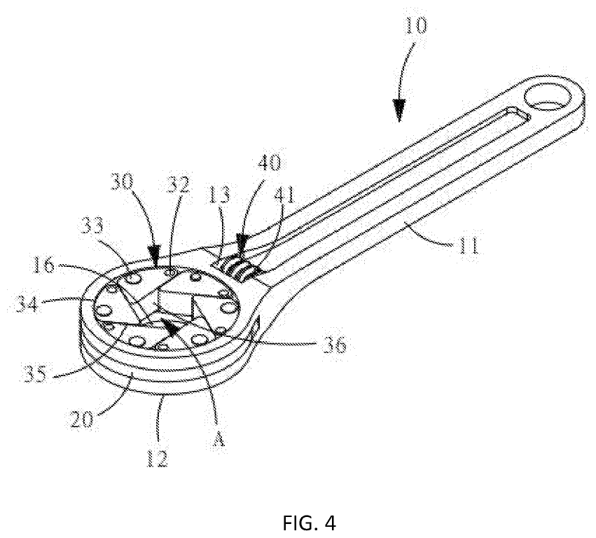

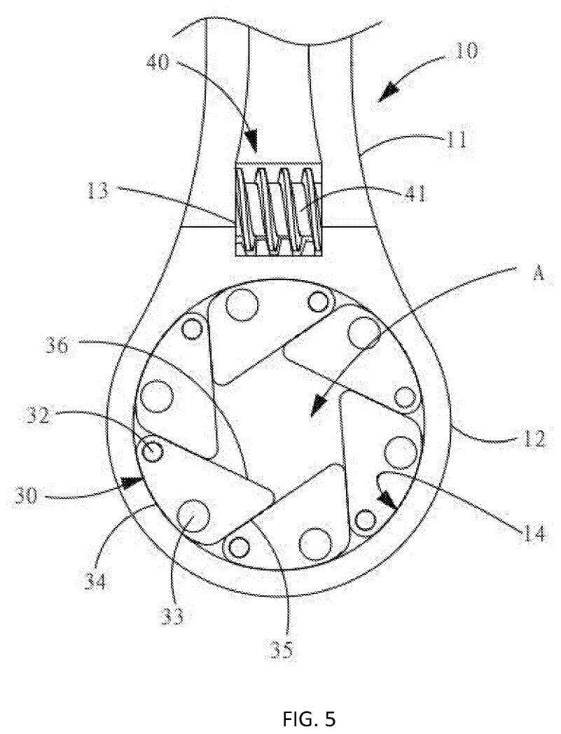

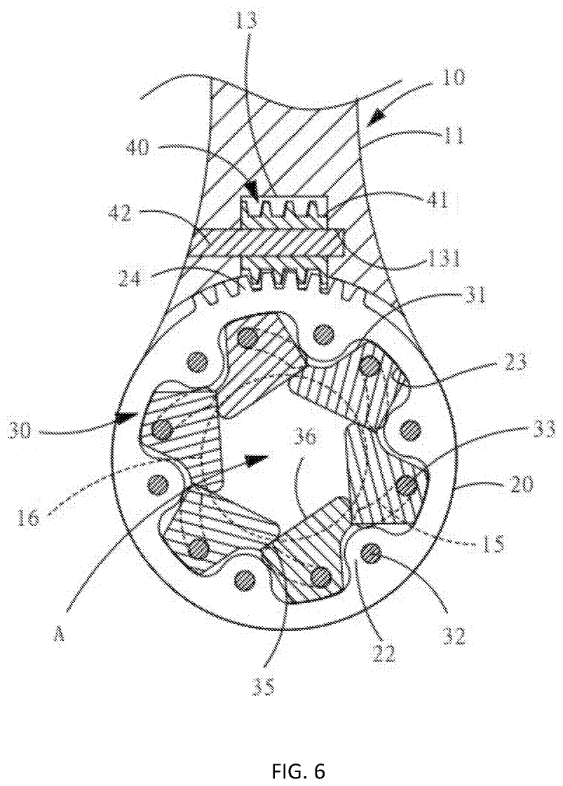

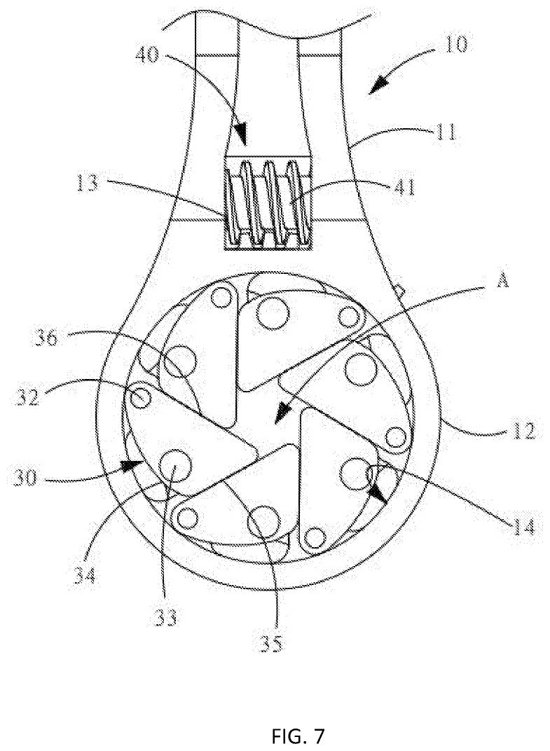

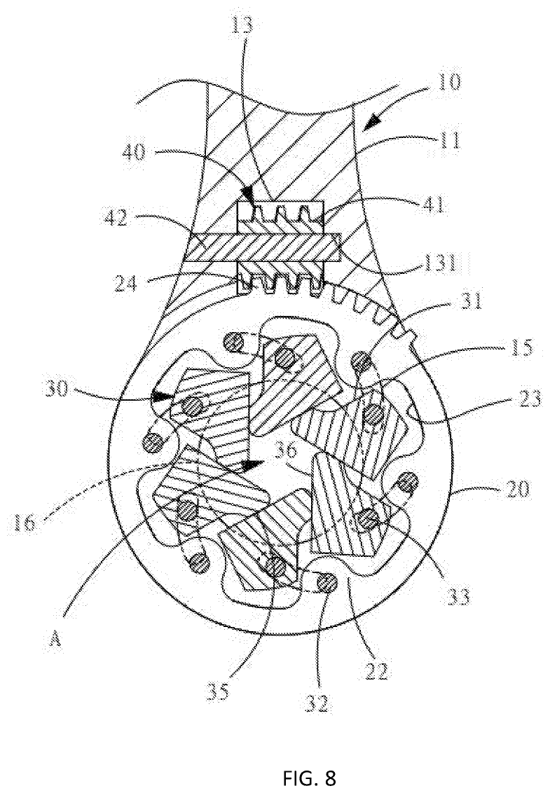

Referring to FIGS. 1-8, the present invention comprises: a pull rod 10, a driving plate 20, six pawls 30, and an adjustment member 40.

The pull rod 10 comprises a holding portion 11 and a header 12 extended from an end of the holding portion 11. The holding portion 11 comprises an accommodating groove 13 sunkenly arranged on the top surface at the position close to the header 12 and a mounting hole 131 crossing the accommodating groove 13. The header 12 has a blind hole 14 defined and provided thereon. The blind hole 14 has a circular peripheral wall 141, an open end 142 as the top of the circular peripheral wall 141, and a closed end 143 as the bottom of the circular peripheral wall 141. The blind hole 14 is formed by the circular peripheral wall 141, the open end 142, and the closed end 143. The header 12 has six first rails 15 arranged on the closed end 143 in an equiangular manner. Each first rail 15 is a curvy groove penetrating the closed end 143. The closed end 143 further has a through hole 16 penetratingly arranged thereon within the extent and range of the six first rails 15. The bore dimension of the through hole 16 is shrunk to, which means smaller than, the blind hole 14, while they are coaxial to each other. The header 12 also comprises a split slot 17 radially penetrating the blind hole 14 at the position next to the closed end 143, so as to divide the header 12 into an upper portion and a lower portion. An end of the split slot 17 reaches the inside of the accommodating groove 13.

The driving plate 20 is ring shaped and is correspondingly inserted into the split slot 17, so as to be coupled with the header 12. The driving plate 20 also has a middle hole 21 in an internal teeth shape defined in the extent of the blind hole 14 coaxial to the blind hole 14. The minimum bore dimension of the middle hole 21 is greater than the through hole 16. The middle hole 21 is in an internal teeth shape, which then defines a plurality of bearing portions 22 between each two first rails 15 to correspond to thick tooth areas in an equiangular manner and defines a plurality of hollow portions 23 between each two bearing portions 22 to correspond to tooth space areas. The driving plate 20 also has a first hole 221 arranged on each bearing portion 22 respectively and a plurality of external teeth 24 arranged on the periphery thereof outside of the extent of the accommodating groove 13.

The pawls 30 are surroundingly arranged around the blind hole 14. The top surface of the pawl 30 is approximately triangle, so as for crossing adjacent bearing portions 22 and first rails 15. The pawl 30 also has a thickening portion 31 downward extended therefrom at the position corresponding to the hollow portion 23 to lean against the closed end 143. The pawl 30 has a stud shaft 32 to pivot joint the pawl 30 on the corresponding first hole 221 of the bearing portion 22, an axial-shaped second rail 33 matching the corresponding first rail 15, a curvy side 34 matching the circular peripheral wall 141 of the blind hole 14, an intermediary side 35 connected with an end of the curvy side 34, and a detent side 36 connected with the other end of the intermediary side 35, such that adjacent pawls 30 are engaged with one another through engaging the intermediary sides 35 with part of the detent sides 36 respectively, so as to symmetrically define a hexagonal hole A through the rest part of the detent sides 36 of the pawls 30 in the extent of the middle hole 21. The hexagonal hole A is coaxial to the blind hole 14. Specifically, the way that the stud shaft 32 pivot joints the pawl 30 includes providing a second hole 37, which matches the corresponding first hole 221, on the pawl 30, having the stud shaft 32 pass through the first hole 221 and the second hole 37, and finishing the pivot jointing through riveting process. Specifically, the way that the second rail 33 is arranged includes providing a third hole 38, which matches the corresponding first rail 15 as a curvy groove, on the pawl 30, having the second rail 33 penetrate the corresponding first rail 15 and the third hole 38, and finishing the mounting through riveting process.

The adjustment member 40 is formed by a worm 41 and a spindle 42. The worm 42 is placed in the accommodating groove 13 of the pull rod 10 and meshes with the external teeth 24 on the periphery of the driving plate 20. The spindle 42 axially penetrates the worm 41. The two ends of the spindle 42 are mounted in the mounting hole 131, so as to allow the worm 41 to rotate through the spindle 42 and allow the rotation of the worm 41 to drive the driving plate 20 to rotate as well. The rotation of the driving plate 20 relies on that the curvy sides 34 of the pawl 30 can move along the circular peripheral wall 141 of the blind hole 14. The stud shafts 32 coupled with the driving plate 20 can drive the pawls 30 and bring the second rails 33 to limit slip along corresponding first rails 15 respectively and synchronously, which controls the pawls 30 to swing along predetermined tracks for adjusting the bore dimension of the hexagonal hole A in a stepless manner, which allows it to be utilized in screwing or unscrewing nuts or screwheads of various sizes.

It is worth mentioning that the quantity of the pawl 30 may also be three, instead of six, as long as the quantity of the pawl 30 is enough for clamping a hexagon screwhead of a regular bolt.

Based on the above illustration of the structure, the present invention has at least the following advantages.

First, the pawls 30 utilize corresponding stud shafts 32 as the pivot points respectively along with the coordination of the corresponding second rails 33 and first rails 15, so as to swing along predetermined tracks respectively, which is a two-point locating technology. Especially, the second rail 33 can directly transfer the stress or torque to the header 12. Therefore, it is advantageous in not only dispersive stress, but also guarantee on that the pawls will act according to the designed path.

Second, the worm 42 meshes with the external teeth 24 is a kind of worm drive, which is similar with a gear reduction unit and provides a greater force moment, such that it can bear the stress or torque transferred from the stud shaft 32.

Third, the driving plate 20 is arranged next to the closed end 143 of the blind hole 14, such that the top sides of the pawls 30 are totally free. Therefore, when they clamp a relatively large nut or screwhead, the interference of the conventional technology is not likely to occur. Namely, the present invention can provide more universal dimensions and utilization.

To sum up, the overall structure and arrangement of the present invention is novel and advantageous, which is certainly a great creation of a technical construct and shall match the conditions of patent application. Therefore, it is applied herein in accordance with the law. However, what has been mentioned above is only one of the preferred embodiments of the present invention, which shall not be used to limit the scope of the practice of the present invention. In other words, all equivalent alternatives and modifications according to the claims of the present invention shall still be covered by the claimed scope of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A pawl wrench of multiple working dimensions, comprising:
a pull rod, comprising a header arranged thereon, wherein said header has a blind hole arranged thereon, wherein said blind hole has an open end, a closed end, and a plurality of first rails arranged on said closed end in an equiangular manner;
a driving plate, coupled with said header, wherein said driving plate has a plurality of bearing portions defined in said blind hole in an equiangular manner and a plurality of external teeth on the periphery thereof;
a plurality of pawls, surroundingly arranged in said blind hole and crossing adjacent said bearing portions and said first rails, wherein each said pawl has a stud shaft and a second rail respectively, wherein said pawls are pivot jointed on said bearing portions through said stud shafts respectively and match said second rails with said first rails, so as to symmetrically define a hexagonal hole with said pawls; and
an adjustment member coupled with said pull rod, wherein said adjustment member is adapted for driving said external teeth to rotate said driving plate, so as to drive said pawls through said stud shafts and bring said second rails of said pawls to limit slip along corresponding first rails respectively and synchronously, which controls said pawls to swing along predetermined tracks for adjusting the bore dimension of said hexagonal hole in a stepless manner.

2. The pawl wrench of multiple working dimensions, as recited in claim 1, wherein said adjustment member comprises a worm.

3. The pawl wrench of multiple working dimensions, as recited in claim 2, wherein said pull rod comprises a holding portion extended from said header, wherein said holding portion comprises an accommodating groove arranged close to the position of said header and a mounting hole crossing said accommodating groove, wherein said worm is accommodated in said accommodating groove, wherein said worm comprises a spindle axially pass through said worm, wherein said spindle has two ends, mounted in said mounting hole, so as to allow said worm to rotate through said spindle.

4. The pawl wrench of multiple working dimensions, as recited in any of claim 3, wherein said blind hole has a circular peripheral wall, an open end as the top of said circular peripheral wall, and a closed end as the bottom of said circular peripheral wall, wherein said header comprises a split slot radially penetrating said blind hole at the position next to said closed end, so as to divide said header into an upper portion and a lower portion, wherein an end of said split slot reaches the inside of said accommodating groove, wherein said driving plate correspondingly is inserted into said split slot and said external teeth thereof are inserted into said accommodating groove.

5. The pawl wrench of multiple working dimensions, as recited in any of claim 1, wherein said pull rod comprises a holding portion extended from said header, wherein said holding portion comprises an accommodating groove for coupling with said adjustment member, wherein said blind hole has a circular peripheral wall, an open end as the top of said circular peripheral wall, and a closed end as the bottom of said circular peripheral wall, wherein said header comprises a split slot radially penetrating said blind hole at the position next to said closed end, so as to divide said header into an upper portion and a lower portion, wherein an end of said split slot reaches the inside of said accommodating groove, wherein said driving plate correspondingly is inserted into said split slot and said external teeth thereof are inserted into said accommodating groove.

6. The pawl wrench of multiple working dimensions, as recited in any of claim 2, wherein said pull rod comprises a holding portion extended from said header, wherein said holding portion comprises an accommodating groove for coupling with said adjustment member, wherein said blind hole has a circular peripheral wall, an open end as the top of said circular peripheral wall, and a closed end as the bottom of said circular peripheral wall, wherein said header comprises a split slot radially penetrating said blind hole at the position next to said closed end, so as to divide said header into an upper portion and a lower portion, wherein an end of said split slot reaches the inside of said accommodating groove, wherein said driving plate correspondingly is inserted into said split slot and said external teeth thereof are inserted into said accommodating groove.

7. The pawl wrench of multiple working dimensions, as recited in claim 5, wherein said closed end of said blind hole has a through hole arranged thereon, wherein the bore dimension of said through hole is symmetrically shrunk to said blind hole, wherein said driving plate is ring shaped and defines a middle hole in said blind hole coaxial to said blind hole, wherein said pawls symmetrically define said hexagonal hole within the extent of said middle hole.

8. The pawl wrench of multiple working dimensions, as recited in claim 6, wherein said closed end of said blind hole has a through hole arranged thereon, wherein the bore dimension of said through hole is symmetrically shrunk to said blind hole, wherein said driving plate is ring shaped and defines a middle hole in said blind hole coaxial to said blind hole, wherein said pawls symmetrically define said hexagonal hole within the extent of said middle hole.

9. The pawl wrench of multiple working dimensions, as recited in claim 7, wherein said middle hole is in an internal teeth shape, so as to define said bearing portions between each two said first rails to correspond to thick tooth areas, which defines hollow portions between each two said bearing portions to correspond to tooth space areas, wherein each said pawl respectively has a thickening portion downward extended therefrom at the position corresponding to said hollow portion respectively to lean against said closed end.

10. The pawl wrench of multiple working dimensions, as recited in claim 8, wherein said middle hole is in an internal teeth shape, so as to define said bearing portions between each two said first rails to correspond to thick tooth areas, which defines hollow portions between each two said bearing portions to correspond to tooth space areas, wherein each said pawl respectively has a thickening portion downward extended therefrom at the position corresponding to said hollow portion respectively to lean against said closed end.

11. The pawl wrench of multiple working dimensions, as recited in any of claim 1, wherein said driving plate has a first hole arranged on each said bearing portion respectively, wherein each said pawl has a second hole arranged thereon matching said first hole respectively, so as to allow each said stud shaft to pass through said first hole and said second hole respectively, wherein each said first rail is a curvy groove penetrating said closed end, wherein each said pawl further has a third hole matching each said curvy groove respectively, so as to allow said second rail to axially penetrate said first rail and said third hole.

12. The pawl wrench of multiple working dimensions, as recited in any of claim 2, wherein said driving plate has a first hole arranged on each said bearing portion respectively, wherein each said pawl has a second hole arranged thereon matching said first hole respectively, so as to allow each said stud shaft to pass through said first hole and said second hole respectively, wherein each said first rail is a curvy groove penetrating said closed end, wherein each said pawl further has a third hole matching each said curvy groove respectively, so as to allow said second rail to axially penetrate said first rail and said third hole.

13. The pawl wrench of multiple working dimensions, as recited in any of claim 3, wherein said driving plate has a first hole arranged on each said bearing portion respectively, wherein each said pawl has a second hole arranged thereon matching said first hole respectively, so as to allow each said stud shaft to pass through said first hole and said second hole respectively, wherein each said first rail is a curvy groove penetrating said closed end, wherein each said pawl further has a third hole matching each said curvy groove respectively, so as to allow said second rail to axially penetrate said first rail and said third hole.

14. The pawl wrench of multiple working dimensions, as recited in any of claim 4, wherein said driving plate has a first hole arranged on each said bearing portion respectively, wherein each said pawl has a second hole arranged thereon matching said first hole respectively, so as to allow each said stud shaft to pass through said first hole and said second hole respectively, wherein each said first rail is a curvy groove penetrating said closed end, wherein each said pawl further has a third hole matching each said curvy groove respectively, so as to allow said second rail to axially penetrate said first rail and said third hole.

15. The pawl wrench of multiple working dimensions, as recited in any of claim 1, wherein each said pawl further has a curvy side matching the circular peripheral wall of said blind hole, an intermediary side connected with an end of said curvy side, and a detent side connected with the other end of said intermediary side, such that adjacent said pawls are engaged with one another through engaging said intermediary sides with part of said detent sides respectively, so as to define said hexagonal hole through the rest part of said detent sides of said pawls.

16. The pawl wrench of multiple working dimensions, as recited in any of claim 2, wherein each said pawl further has a curvy side matching the circular peripheral wall of said blind hole, an intermediary side connected with an end of said curvy side, and a detent side connected with the other end of said intermediary side, such that adjacent said pawls are engaged with one another through engaging said intermediary sides with part of said detent sides respectively, so as to define said hexagonal hole through the rest part of said detent sides of said pawls.

17. The pawl wrench of multiple working dimensions, as recited in any of claim 3, wherein each said pawl further has a curvy side matching the circular peripheral wall of said blind hole, an intermediary side connected with an end of said curvy side, and a detent side connected with the other end of said intermediary side, such that adjacent said pawls are engaged with one another through engaging said intermediary sides with part of said detent sides respectively, so as to define said hexagonal hole through the rest part of said detent sides of said pawls.

18. The pawl wrench of multiple working dimensions, as recited in any of claim 4, wherein each said pawl further has a curvy side matching the circular peripheral wall of said blind hole, an intermediary side connected with an end of said curvy side, and a detent side connected with the other end of said intermediary side, such that adjacent said pawls are engaged with one another through engaging said intermediary sides with part of said detent sides respectively, so as to define said hexagonal hole through the rest part of said detent sides of said pawls.
